(19) United States
(12) Patent Application Publication
(10) Pub. No.: US 2002/0053787 A1
(43) Pub. Date: May 9, 2002

(54) Vehicle airbag system operable at different levels of bag deployment

(76) Inventor: Remon Hanoun, Newmarket (CA)

Correspondence Address: Dennison Associates, Suite 301, 133 Richmond Street West, Toronto, ON, M5H 2L7, CA

(21) Appl. No.: 09/985,205

(22) Filed: Nov. 2, 2001

(30) Foreign Application Priority Data
Nov. 3, 2000 (CA) 2,325,128

(51) Int. Cl. B60R 21/32

(52) U.S. Cl. 280/734

(57) ABSTRACT

A vehicle impact protection system comprises an airbag deployable at a seating region of a vehicle dependent upon size of an individual exposed to the airbag and/or distance of the individual from the airbag. The system includes a sensor for sensing size and/or distance information for a person sitting in front of the airbag, and a controller which receives the information and controls deployment of the airbag accordingly. The system includes a sensor for sensing size information of the person sitting in the seating region and a controller which receives the information from the sensor and which enables the airbag to deploy to only one of the levels of deployment depending upon the information sensed by the sensor.

### FIELD OF THE INVENTION

The present invention relates to an airbag system in a motor vehicle.

### BACKGROUND OF THE INVENTION

Typically, airbags are very helpful in preventing injuries in automobile accidents. However, in some cases the airbag can be more of detriment than a help. In some cases, in automobiles accidents where young children are involved airbags have actually been the cause of death rather than preventing injury. In other cases deployment of an airbag at a person sitting very close to the airbag has caused injuries.

I have dealt with the first of the above problems in my earlier Canadian patent application S.N. 2,240,749 published Dec. 17, 1999. According to my early patent application I provide sensors which sense the size of a person in a vehicle seat exposed to an airbag. If the person e.g. a child or the like, is below a certain preset size then the airbag will not deploy whatsoever.

### SUMMARY OF THE PRESENT INVENTION

The present application relates to an vehicle impact protection system along similar lines and having additional features to my earlier disclosed system.

In particular, the vehicle impact protection system of the present invention comprises airbag means deployable to different levels of deployment at a seating region of a vehicle and sensing means which sense size and/or distance information regarding an occupant in the seating region. The deployment of the airbag means is dependent upon the information sensed by the sensing means.

According to the system of the present invention, in a crash situation the airbag will either not deploy at all or will deploy sufficiently to help prevent injuries to either a child or an adult, with little likelihood that the airbag itself will cause injury.

### BRIEF DESCRIPTION OF THE DRAWINGS

The above as well as other advantages and features of the present invention will be described in greater detail according to the preferred embodiments of the present invention in which;

FIG. 1 is a perspective view looking down on a seating region of a vehicle equipped with the vehicle impact protection system according to a preferred embodiment of the present invention.

FIG. 2 is sectional view of the seating region along the lines 22 of FIG. 1.

### DETAILED DESCRIPTION ACCORDING TO THE PREFERRED EMBODIMENTS OF THE PRESENT INVENTION IN WHICH

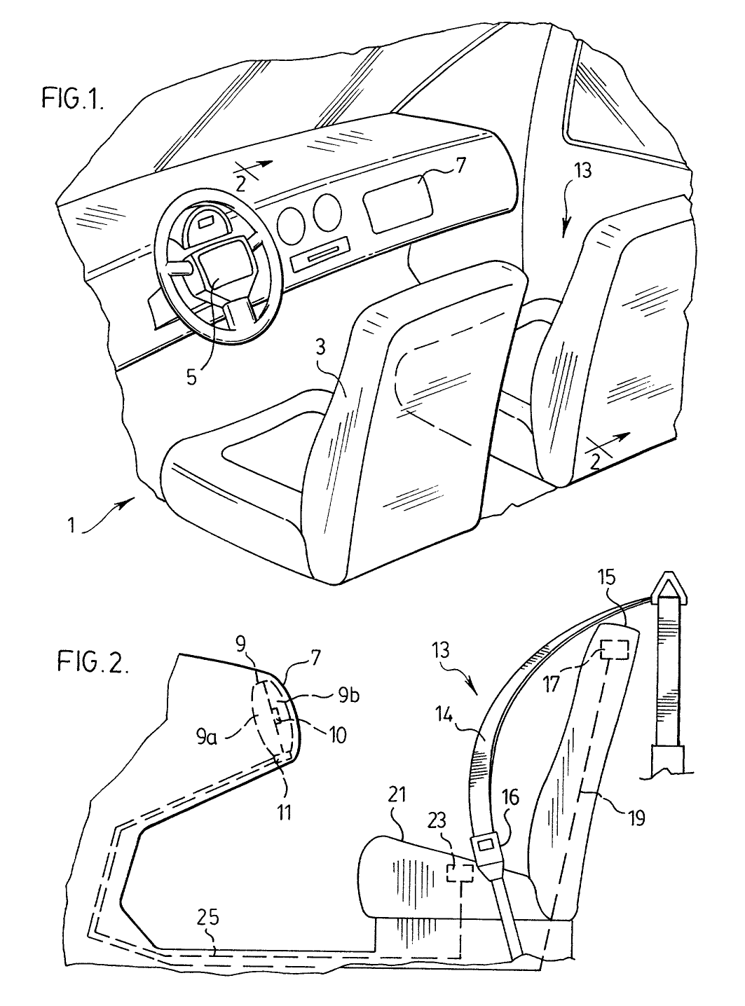

Similar to my earlier described system FIG. 1 shows the front seating area 1 of a motor vehicle. This seating area includes a driver seat 3 with an airbag compartment 5 positioned in front of the driver's seat. Also provided in the seating compartment is a second airbag compartment 7 positioned in front of the passenger seat generally indicated at 13.

As shown in FIG. 2 of the drawing a non-inflated airbag 9 is contained within compartment 7. This airbag is ready for deployment into the passenger seat should the vehicle be involved in a accident.

Seat 13 has an upright back cushion 15 and a lower seating cushion 21. The seat also includes a seat belt 14.

A sensor 17 is positioned within the back cushion 15, sensor 23 within the seating cushion 21 and a sensor 16 along the inside surface of seat belt 14.

All of the sensors feed to a controller 11 for the airbag 9. Controller 11 is preprogrammed with a guide level for deployment of the airbag means. Information sent from the sensors is compared with that guide level as discussed below.

The sensors 16 and 17, which may be in the form of photo sensors or even pressure sensors sense the height of an occupant sitting in the passenger's seat.

Sensor 23 senses the weight of the occupant which would typically be indicative of the overall size of the person.

In the arrangement shown airbag 9 has a main airbag compartment 9a and a secondary or auxiliary airbag compartment 9b. These two compartments are separated by means of a valve 10.

If either the height or the weight or both the height and weight of the occupant are below a certain specified level then the controller which receives this information enables only the deployment of the main compartment 9a of the airbag by maintaining valve 10 closed. Accordingly, in the event of a crash a child size small person, will only be exposed to the deployment of the main compartment of the airbag. This is sufficient to block forward movement without being crushing on the child.

In the event that any one or all of the sensors senses that the person in the seat in a much larger person e.g. an adult, this information is fed to controller 11. Controller 11 then enables the deployment of both the main and the auxiliary compartments of the airbag by opening the valve 10. This allows a much greater level of inflation of the airbag to absorb the impact of larger person sitting in the vehicle seat.

Airbag means other than that shown and described above, could equally as well be used for the multiple levels of deployment of the airbag. For instance, there could be two totally separate airbags provided in compartment 7 with one bag being deployable specifically for children and the other bag being deployable specifically for an adult.

In another embodiment, the airbag means could be simply one large airbag which only inflates to a certain extent when the system senses the presence of a smaller person in front of the airbag and which inflates to a much greater extent when there is a larger person exposed to the airbag.

The description above relates to deployment of the airbag dependent upon size of the individual. It is also important to control deployment of the airbag dependent upon distance of the individual from the air. This is because full deployment of the airbag at a person too close to the airbag can also cause injury. For example, a person, whether a large or small person, can be seriously injured by a standard fully deployment airbag if that person is sitting within about 10 inches of the airbag. Outside of that distance injury is less likely.

The present invention also compensates for this particular problem by incorporating a distance sensor 25 which is also wired to the airbag controller 11. This distance sensor senses, through the use of a rebound light or otherwise, distance of the person from the sensor which is itself located adjacent the airbag. The distance information sensed is then fed to controller 11 which sets the degree of deployment according to the information sent to the controller. The degree of deployment could be anywhere from no deployment whatsoever for someone sitting extremely close to the airbag to partial deployment or to full deployment of the airbag.

Note that the controller is simultaneously receiving information from both the size and the distance sensors and will control airbag deployment based on all of the information received. For example, a larger person sitting one foot from the airbag would typically receive a greater deployment than a smaller person at the same distance but may receive the same deployment as or even a lesser deployment than a smaller person at a greater distance. All of these factors are accounted for by the controller which is programmed to react accordingly.

It is also to be understood that although the application describes the use of the airbag system in the front passenger seat of a vehicle it could be used just as easily be in any other seating region of the vehicle.

Although various preferred embodiments of the invention have been described in detail, it will be appreciated by those skilled in the art that variations may be made without the departing from the sprit of the invention or the scope of the appended claims.

The embodiments of the invention in which an exclusive property or privilege is claimed are defined as follows:

1. A vehicle impact protection system comprising airbag means deployable to different levels of deployment at a seating region of a vehicle and sensing means which senses size information regarding an occupant in the seating region, said airbag means being enabled to deploy to one of said levels of deployment dependent upon the information sensed by said sensing means.

2. A vehicle impact protection system comprising airbag means deployable at a seating region of a vehicle to a small person level of deployment and to a large person level of deployment, sensing means for sensing size information of a person in the seating region and control means which receives the information from the sensing means and which enables said airbag means to deploy to only one of said levels of deployment depending upon the information sensed by said sensing means.

3. A vehicle impact protection system as claimed in claim 2 wherein said airbag means comprises a single airbag which inflates to different levels to provide said small person level of deployment and said large person level of deployment.

4. A vehicle impact protection system as claimed in claim 2 wherein said airbag mean comprises a main airbag member which inflates to provide, on its own, the small person level of deployment, and a supplement airbag member which inflates in combination with said main airbag member to provide the large person level of deployment.

5. A vehicle impact protection system as claimed in claim 2 wherein said seating region comprises a seat bottom, a seat back and a seat belt, said sensing means being located in at least one of said seat bottom, said seat back and said seat belt.

6. A vehicle impact protection system comprising airbag means facing a seating region of a vehicle and sensing means which sense one of size information and distance information regarding an occupant in the seating region, said airbag means being controlled to deploy to different levels of deployment according to the size information sensed, and being in once of a deploy enabled mode and a deployment disabled made according to the distance information sensed.

7. A vehicle impact protection system comprising airbag means facing a vehicle seating region and a sensor which senses distance information relating to distance from the airbag means of an individual located in the seating region, said airbag means being controlled by said system to operate in one of a deployment enabled made and a deployment disabled mode according to the distance information sensed by said senor.
